(19) United States
(12) Patent Application Publication
(10) Pub. No.: US 2006/0262041 A1
(43) Pub. Date: Nov. 23, 2006

(54) Apparatus and method for operating plasma display panel

(76) Inventor: Yang Ki An, Kyungsangbuk-do (KR)

Correspondence Address: FLESHNER & KIM, LLP, P.O. BOX 221200, CHANTILLY, VA, 20153, US

(21) Appl. No.: 11/367,695

(22) Filed: Mar. 6, 2006

(30) Foreign Application Priority Data
May 17, 2005 (KR) 10-2005-0041175

(51) Int. Cl. G09G 3/28

(52) U.S. Cl. 345/67

(57) ABSTRACT

An apparatus and method for operating a plasma display panel (PDP) capable of removing or preventing peaking noise or voltage spike is disclosed. After substantial video data is completely recorded in the address electrode and/or after the last scan pulse or signal on the last scan electrode, the apparatus floats the address electrode or maintains the address electrode at a predetermined voltage, such that it prevents peaking noise from being received from the scan electrode and the sustain electrode, resulting in no erroneous discharge. As a result, the apparatus improves an image quality of the PDP, and increases operation efficiency of the PDP including use of single scan rather than dual scan.

### BACKGROUND OF THE INVENTION

1. Field of the Invention

The present invention relates to a display device and more particularly, an apparatus and a method for operating a plasma display panel.

2. Background of the Related Art

Generally, a plasma display panel (PDP) performs luminescence of a fluorescent substance using a Vacuum Ultraviolet ray of 147 nm generated during the discharge time of He+Xe gas, Ne+Xe gas, or He+Ne+Xe gas, such that it can display an image including character or graphic data. FIG. 1 illustrates the method to provide grey level or scale in a PDP.

As shown, a single frame is divided into a plurality of subfields having different light-emission numbers, such that the divided subfields are driven according to a time-division scheme. Each subfield includes a reset period R for generating a uniform discharge operation, an address period A for selecting a discharge cell, and a sustain period S for implementing a grey level according to the number of discharges.

For example, if a user desires to indicate a desired image in 256 grey levels, a frame period of 16.67 ms equal to 1/60 second is divided into 8 subfields, and each subfield is classified into a reset period R, an address period A, and a sustain period S. The reset period R and the address period A of each subfield are equal to those of other subfields, but the sustain period S increases in each subfield at a predetermined rate of 2ⁿ(n=0, 1, 2, 3, 4, 5, 6, and 7).

FIG. 2 shows a waveform diagram illustrating signals for driving a PDP. A PDP is driven by three periods in each subfield, e.g., a reset period R for initializing all screen images or cells, an address period A for selecting a corresponding discharge cell, and a sustain period S for sustaining a discharge of the selected cell.

During the reset period R, a setup signal (R_up) of a rising ramp signal (also called a ramp-up signal) is applied to all scan electrodes Y. A setup discharge occurs in a discharge cell of all screen images by the setup signal (R_up). Due to the setup discharge operation, wall charges of positive polarity are accumulated in an address electrode X and a sustain electrode Z, and wall charges of negative-polarity are accumulated in the scan electrode Y.

Subsequently, a setdown signal (R_dn) of a falling ramp signal (also called a ramp-down signal), which descends from a positive-polarity voltage less than a peak voltage of the setup signal (R_up) to a ground voltage (GND) or a negative-polarity specific voltage level, is applied to a discharge cell.

If the setdown signal (R_dn) is applied to the discharge cell, a discharge occurs in the discharge cell, such that some parts of wall charges excessively formed in the discharge cell are eliminated. Wall charges capable of generating a stable address discharge are uniformly formed in the discharge cell at this time.

A negative-polarity scan pulse (scp) having a voltage magnitude of Vy is applied to the scan electrode Y during the address period A, and at the same time is synchronized with that a positive-polarity data pulse (dp) of voltage magnitude Va is applied to the address electrode X. A wall voltage caused by wall charges formed during the reset period R is added to a voltage difference between the scan pulse (scp) and the data pulse (dp), such that an address discharge occurs in the discharge cell to which the data pulse (dp) is applied. Cells selected by the address discharge form wall charges capable of generating a sustain discharge at a reception time of a sustain signal having a voltage magnitude of Vs.

A bias voltage (Vzb) of positive polarity is applied to the sustain electrode Z during a predetermined time corresponding to the sum of the address period A and the setdown signal (R_dn) time. A voltage difference between the scan electrode Y and the sustain electrode Z is reduced, resulting in the prevention of erroneous discharges.

The sustain pulse (sus) is alternately applied to the scan electrode Y and the sustain electrode Z during the sustain period S. A discharge cell generating the address discharge adds a sustain voltage (Vs) to an internal wall voltage upon receiving the sustain pulse (sus), resulting in the occurrence of a sustain discharge. Therefore, the discharge cell generating the address discharge generates a sustain discharge between the scan electrode Y and the sustain electrode Z whenever the sustain pulse (sus) is applied.

After completing the sustain discharge, a ramp signal having a narrow pulse width and a low voltage level is applied to the sustain electrode Z, such that wall charges remaining in all discharge cells are eliminated. In this method, a leakage current instantaneously occurs in the scan electrode Y and the sustain electrode Z at a specific time at which data is completely recorded in the address electrode X during the address period A, resulting in the occurrence of peaking noise. If the peaking noise (Pn) or a voltage spike occurs at the end of the address period A, data record operation is not stably completed, Hence, wall charges formed in the scan electrode Y and the sustain electrode Z become unstable. Although the sustain pulse (sus) is applied to the scan electrode Y and the sustain electrode Z during the sustain period S, a sustain discharge is not correctly generated, resulting in deterioration of image quality of the plasma display panel.

If the peaking noise or the voltage spike occurs in the PDP, wall charges are excessively formed in the scan electrode Y and the sustain electrode Z there may arise overcharge, resulting in the sputtering of a brilliant spot. Alternatively, the wall charges are removed by the peaking noise (Pn), the degree of sustain discharge is lowered such that erroneous discharge occurs, resulting in deterioration of brightness and image-quality characteristics of the plasma display panel.

The above references are incorporated by reference herein where appropriate for appropriate teachings of additional or alternative details, features and/or technical background.

### SUMMARY OF THE INVENTION

An object of the invention is to solve at least the above problems and/or disadvantages and to provide at least the advantages described hereinafter.

An object of the present invention is to improve brightness.

An object of the present invention is to improve image quality.

It is another object of the invention to provide an apparatus and method for operating a plasma display panel, which applies a stabilization waveform signal to an address electrode at a specific time at which video data is completely recorded in the address electrode, and prevents peaking noise from being received from a scan electrode and a sustain electrode.

In accordance with one aspect of the present invention, these objects are accomplished by providing a method for operating a plasma display panel (PDP), comprising the steps of: a) applying a data pulse to an address electrode; and b) applying a scan pulse to a scan electrode in response to the data pulse, wherein the address electrode has a predetermined waveform signal different from that of the data pulse after the scan pulse is completely applied to the scan electrode.

Preferably, the predetermined waveform signal is applied to the address electrode after substantial video data is completely recorded in the address electrode, and must be terminated before video data is recorded in the next address electrode.

The predetermined waveform signal controls a signal line connected to a plurality of switches capable of transmitting a the data pulse to the address electrode, such that it floats the address electrode.

In accordance with another aspect of the present invention, there is provided a method for operating a plasma display panel (PDP), comprising the steps of: a) applying a data pulse to an address electrode; b) applying a scan pulse to a scan electrode in response to the data pulse; and c) applying one or more sustain pulses to the scan electrode during a sustain period, wherein the address electrode is floated after the scan pulse is completely applied to the scan electrode.

In accordance with yet another aspect of the present invention, there is provided a plasma display panel (PDP) apparatus comprising: a first drive for applying a data pulse to an address electrode; and a second drive for applying a scan pulse to a scan electrode in response to the data pulse, wherein the address electrode has a predetermined waveform signal different from that of the data pulse after the scan pulse is completely applied to the scan electrode.

In other words, after data is completely recorded in the address electrode, the PDP apparatus floats the address electrode, such that it prevents peaking noise from being generated. Therefore, the PDP apparatus prevents wall charges formed in the scan electrode and the sustain electrode are eliminated by the peaking noise, such that it can stably perform a discharge operation.

The present invention can be achieved in a whole or in parts by a method for operating a plasma display panel (PDP), comprising: a) applying a scan pulse (scp) to a scan electrode (Y); and b) applying a data pulse (dp) to an address electrode (X) in response to the scan pulse (scp), wherein the address electrode (X) has a predetermined stabilization waveform signal after a final scan pulse (scp) is completely applied to the scan electrode (Y)

The stabilization waveform signal may maintain a voltage of the data pulse (dp) applied to the address electrode (X) in response to the final scan pulse (scp).

The stabilization waveform signal may be different from the data pulse (dp) applied to the address electrode (X) in response to the last scan pulse (scp). The stabilization waveform signal has some parts, voltage levels of which are higher or less than a maximum voltage level of the data pulse (dp). The method may, further comprise the step of: c) applying one or more sustain pulses (sus) to the scan electrode (Y) during a sustain period. The stabilization waveform signal is terminated before a first sustain pulse (sus1) is applied to the scan electrode (Y). The stabilization waveform signal is terminated when the scan electrode (Y) has a ground (GND) voltage before the first sustain pulse (sus1) is applied to the scan electrode (Y).

The stabilization waveform signal may be formed when the address electrode (X) is floated after the scan pulse (scp) is completely applied to the scan electrode (Y). The address electrode N) is floated by controlling a signal line connected to a plurality of switches contained in a data drive for transmitting the data pulse (dp) to the address electrode (X).

The present invention can be achieved in a whole or in parts by a method for operating a plasma display panel (PDP), comprising the steps of: a) applying a scan pulse (scp) to a scan electrode (Y) during an address period (A); b) applying a data pulse (dp) to an address electrode (X) in response to the scan pulse (scp) during the address period (A); c) applying a final scan pulse (scp) to the scan electrode (Y); and d) floating the address electrode (X) after applying the final scan pulse (scp) to the scan electrode (Y). The method may further comprise e) applying one or more sustain pulses to the scan electrode (Y) during a sustain period (S), wherein a floating end time of the address electrode (I is established before a first sustain pulse (sus1) is applied to the scan electrode (Y). The method may further comprise the step of: f) applying one or more sustain pulses (sus) to the scan electrode (Y) during a sustain period (S), wherein a floating end time of the address electrode (X) is established when the scan electrode (Y) has a ground (GND) voltage before a first sustain pulse (sus1) is applied to the scan electrode (Y).

The present invention can be achieved in a whole or in parts by a plasma display panel apparatus, comprising: a first drive (130) for applying a scan pulse (scp) to a scan electrode (Y); and second drive (120) for applying a data pulse (dp) to an address electrode (X) in response to the scan pulse (scp), wherein the second drive (120) controls the address electrode (X) to have a predetermined stabilization waveform signal after a final scan pulse (scp) is completely applied to the scan electrode (Y).

The second drive (120) preferably maintains a voltage of the data pulse (dp) applied to the address electrode (X) in response to the final scan pulse (scp).

The second drive (120) preferably controls the stabilization waveform signal to have a predetermined waveform different from that of the data pulse (dp) applied to the address electrode (X) in response to the final scan pulse (scp). The stabilization waveform signal has some parts, voltage levels of which are higher or less than a maximum voltage level of the data pulse (dp).

The apparatus may further comprise: a third drive for applying one or more sustain pulses (sus) to the scan electrode (Y) during a sustain period (S). The stabilization waveform signal is terminated before a first sustain pulse (sus1) is applied to the scan electrode (Y). The stabilization waveform signal is terminated when the scan electrode (Y) has a ground (GND) voltage before the first sustain pulse (sus1) is applied to the scan electrode (Y). The stabilization waveform signal is preferably formed when the address electrode (X) is floated after the scan pulse (scp) is completely applied to the scan electrode (Y). The address electrode (X) is floated by controlling a signal line connected to a plurality of switches (H, L) contained in the second drive (120) for transmitting the data pulse (dp) to the address electrode (X).

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 shows a frame structure for driving a plasma display panel;

FIG. 2 is a waveform diagram illustrating signals for driving the a plasma display panel;

FIG. 3 is a structural diagram illustrating a plasma display panel;

FIG. 4a is a waveform diagram illustrating signals for driving a plasma display panel in accordance with an embodiment of the present invention;

FIG. 4b is a waveform diagram illustrating signals for driving a plasma display panel in accordance with an embodiment of the present invention;

FIG. 4c is a waveform diagram illustrating signals for driving a plasma display panel in accordance with an embodiment of the present invention;

FIG. 4d is a waveform diagram illustrating signals for driving a plasma display panel in accordance with an embodiment of the present invention;

FIG. 4e is a waveform diagram illustrating signals for driving a plasma display panel in accordance with an embodiment of the present invention;

FIG. 5 is a waveform diagram illustrating signals for driving a plasma display panel in accordance with an embodiment of the present invention;

FIGS. 6a and 6b are block diagrams illustrating an apparatus for driving a plasma display panel in accordance with the present invention;

FIG. 7 is a waveform diagram illustrating signals for driving a plasma display panel in accordance with a first preferred embodiment of the present invention; and

FIGS. 8a˜8c are waveform diagrams illustrating signals for driving a plasma display panel in accordance with the present invention.

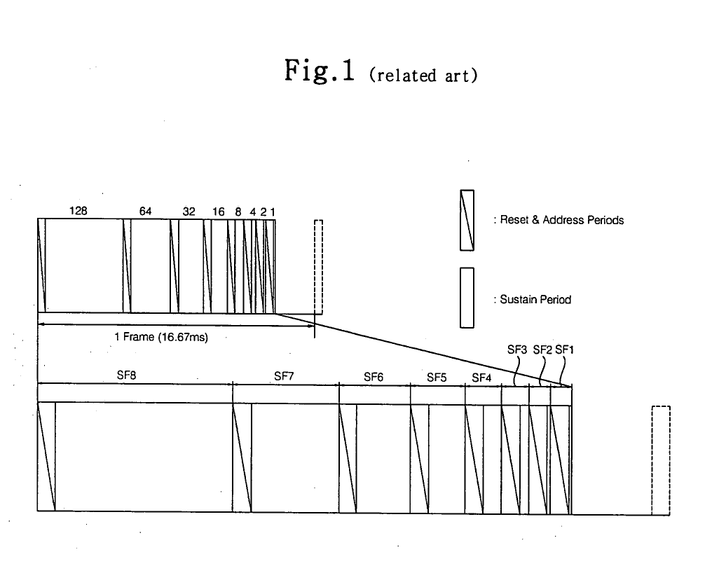

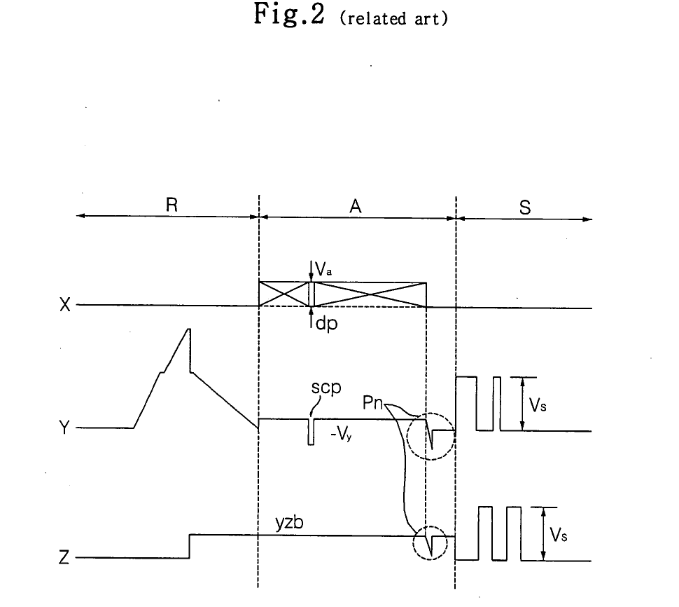

### BEST MODE OR DETAILED DESCRIPTION OF PREFERRED EMBODIMENTS

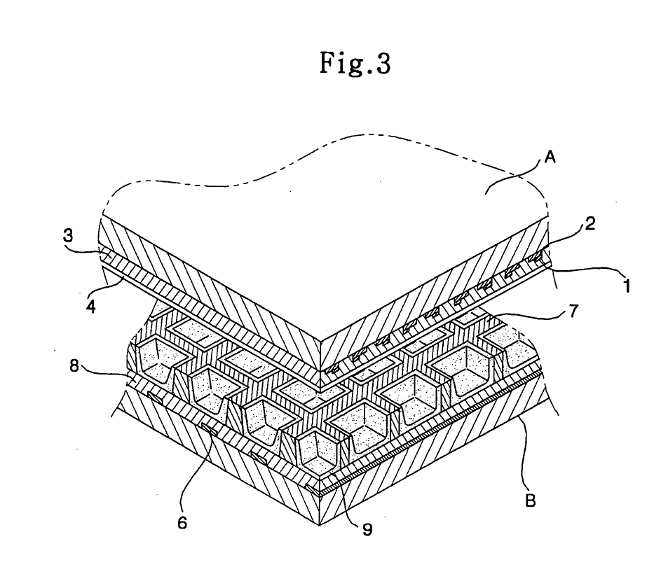

FIG. 3 is a perspective view illustrating a three-electrode AC surface-discharge PDP structure. As shown in FIG. 3, the three-electrode AC surface-discharge PDP structure includes a front substrate A and a rear substrate B. The front substrate A includes a scan electrode 1 and a sustain electrode sequentially formed. The front substrate A further includes a dielectric layer 3 formed on the scan electrode 1 and the sustain electrode 2, and a dielectric passivation layer 4 formed on the dielectric layer 3.

The scan electrode 1 includes a transparent electrode 1a having a relatively wide width, formed of a transparent electrode material, indium tin oxide (ITO), for visible-ray transmission; and a bus electrode 1b having a relatively narrow width, formed of a metal material to compensate for surface resistance of the transparent electrode 1a. Similar to the scan electrode 1, the sustain electrode 2 includes a transparent electrode 2a and a bus electrode 2b. The transparent electrodes 1a and 2a are formed of an ITO (Indium-Tin-Oxide). In an alternative embodiment, each of the scan and sustain electrodes may be formed of one electrode structure rather than ITO and bus electrode.

If a driving signal for operating the plasma display panel is applied to the scan electrode 1 and the sustain electrode 2, a wall discharge is accumulated in the dielectric layer 3, the dielectric passivation layer 4 prevents the dielectric layer 3 from being damaged by a sputtering action, and increases discharge efficiency of secondary electrons. In this case, an MgO is generally used as the dielectric passivation layer 4. In an alternative embodiment, the layers 3 and 4 may be implemented using one layer.

An address electrode 6 is formed on the rear substrate B to allow the scan electrode 1 to be orthogonal to the sustain electrode 2. A dielectric layer 8 for accumulating the wall discharge is formed on the address electrode 6. A partition or barrier rib 7 for dividing a discharge space into predetermined parts and a fluorescent substance 9 are formed on the dielectric layer 8.

The fluorescent substance 9 is deposited on a lateral side of the partition and the bottom of the discharge space, and is excited and light-emitted by ultraviolet rays generated by a discharge operation, and generates one color from among three colors (i.e., Red, Green, and Blue) of visible rays. In an alternative embodiment, the partition may be formed only in the direction of the address electrode, and/or cells may be in a delta configuration instead of row of cells. Inert mixed gas (for example, He+Xe, and Ne+Xe, etc.) is provided into a discharge space of a discharge cell formed among the front substrate A, the rear substrate B, and the partition 7.

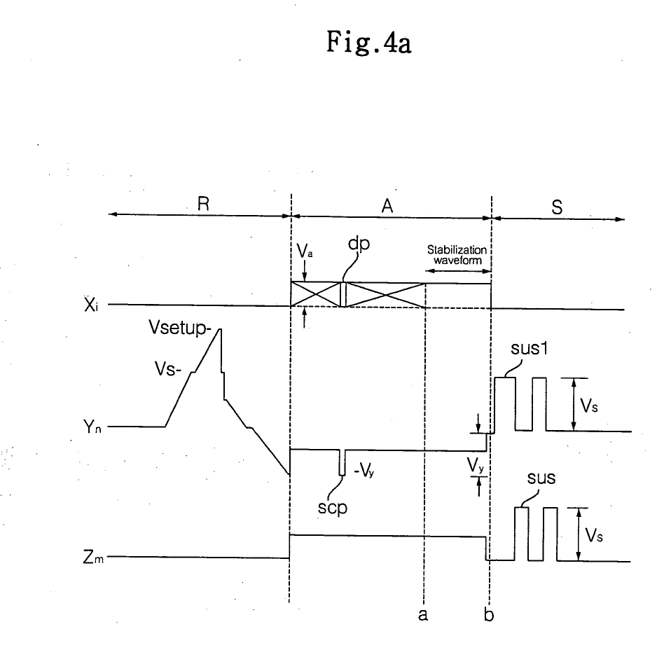

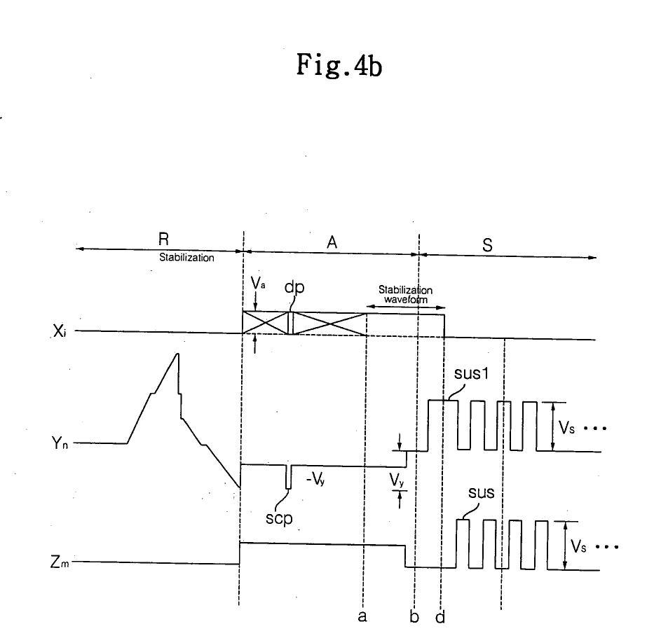

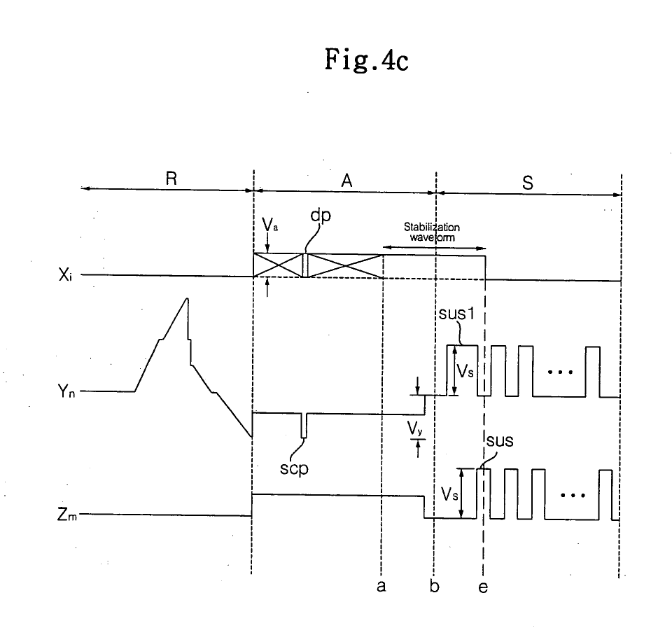

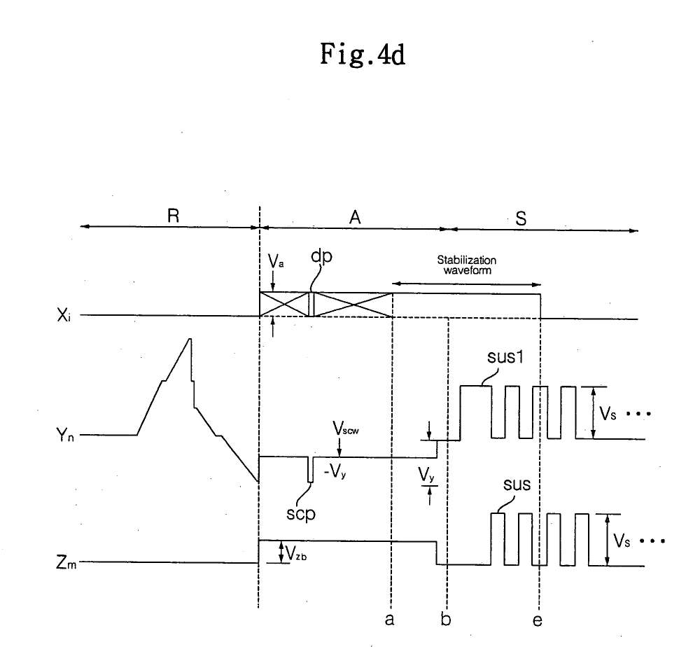

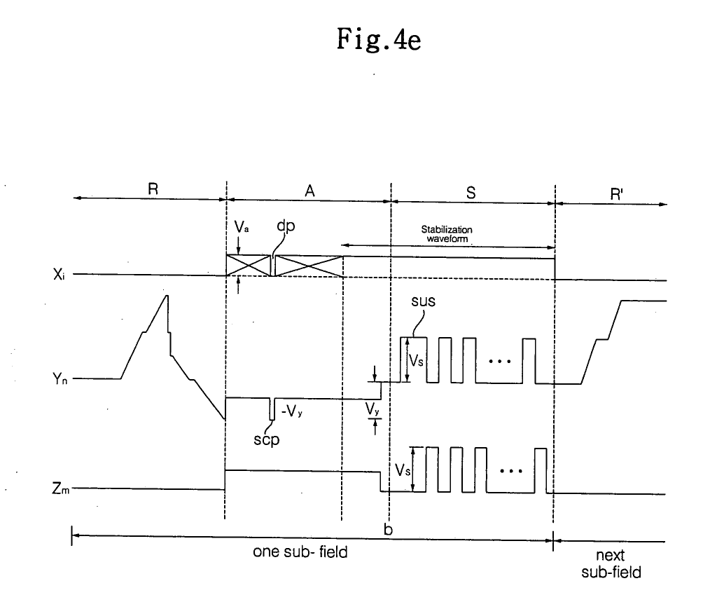

FIGS. 4a˜4e are waveform diagrams illustrating exemplary signals for driving a plasma display panel in accordance with an embodiment of the present invention. Referring to FIG. 4a, a subfield SF begins with a reset period R. A setup signal (R_up) having a positive(+) polarity ramp signal is applied to all scan electrodes Y in the reset period R, and then a setdown signal (R_dn) having negative(−) polarity ramp signal is applied to the scan electrodes Y in the reset period R.

The setup signal (R_up) controls a voltage of each corresponding scan electrode Yn to be gradually increased in the range from a low voltage or 0 voltage to a positive-polarity sustain voltage Vs and then to a setup voltage (Vsetup) higher than the voltage of Vs. The setup signal (R_up) generates a reset discharge between the scan electrode Yn and the address electrode Xi in all discharge cells, such that wall charges occur in the discharge cells. In this case, a voltage of 0V may be applied to the sustain electrode Zm or the address electrode Xi, or a bias voltage may be applied to the sustain electrode Zm, such that a reset discharge is increased.

After the setup signal (R_up) has been applied to the scan electrode Y, the ramp-shaped setdown signal (R_dn) is applied to the scan electrode Y. If the setdown signal (R_dn) is applied to the scan electrode Y, wall charges excessively formed in the discharge cell are eliminated, such that a voltage difference between the corresponding scan electrode Yn and the address electrode Xi occurs in the vicinity of a discharge start voltage.

The data pulse (dp) associated with video data is applied to the corresponding address electrode Xi during the address period A. In response to the data pulse (dp), the scan pulse (scp) having polarity opposite to that of the data pulse (dp) is applied to the corresponding scan electrode Yn. As shown, until the selection of the corresponding scan electrode Yn, the scan electrode Yn is maintained at a prescribed voltage. The prescribed voltage may be a negative bias voltage, e.g., −Vy as shown in FIG. 4a, a ground voltage or a positive bias voltage. The prescribed voltage is based on the general characteristic of the plasma display panel.

The sustain pulse (sus) is alternately applied to the scan electrode (Y) and the sustain electrode (Z) during the sustain period S. Upon receiving the sustain pulse (sus), a specific cell causing an address discharge generates a sustain discharge between the scan electrode Y and the sustain electrode Z, and the sustain discharge executed for all subfields contained in a single frame for providing a grey level or grey scale.

During the address period, after the last scan pulse (scp) is completely applied to the last scan electrode Y, as denoted by “a”, a predetermined stabilization waveform is applied to the address electrode X to prevent peaking noise. As shown in FIG. 4a, the stabilization waveform may be a predetermined signal provided the address electrodes (X) in response to the last scan pulse (scp) applied to the last scan electrode. The predetermined signal may preferably be a constant voltage equal to dp, i.e., a voltage of Va.

Generally, the scan electrode Y and the sustain electrode Z are temporarily maintained at a ground level at an initial time of the sustain period S as denoted by “b”, and the sustain pulse (sus) having polarity opposite to those of the scan electrode Y and the sustain electrode Z is alternately applied to the scan electrode Y and the sustain electrode Z, such that a sustain discharge is performed. In FIG. 4a stabilization waveform signal applied to the address electrode X is ended at a specific point “b” at which a GND voltage is applied to the scan electrode Y after the last scan pulse (scp) is completely applied to the scan electrode Y at a point “a”. If the address electrode X is maintained with the stabilization waveform a start time of the sustain period S, a current signal is not generated from the scan electrode Y or the sustain electrode Z, resulting in no peaking noise.

Alternatively, the stabilization waveform signal may be terminated during a reception time of the sustain pulse (sus). The stabilization waveform signal may be terminated during a predetermined time “d” in which the first sustain pulse (sus1) is applied to the scan electrode Y of the sustain period, as shown in FIG. 4b, or may also be terminated after a predetermined lapse “e” of the first sustain pulse (sus1) as shown in FIG. 4c. After a plurality of sustain pulses (sus) are applied to the scan electrode Y and the sustain electrode Z as shown in FIG. 4d, the stabilization waveform signal applied to the scan electrode Y and the sustain electrode Z may be terminated as necessary. Preferably, if the stabilization waveform signal is terminated after the first sustain pulse (sus1) is applied to the scan electrode Y, it is terminated at a specific time at which the scan electrode Y has a GND voltage. In FIG. 4a˜4c, the first sustain waveform or signal preferably has a wider width than the other sustain waveform or signal. As can be appreciated, the width of this waveform may be adjusted based on the characteristics of the plasma display panel or for preventing erroneous discharges.

For example, it is assumed that the sustain voltage (Vs) having positive(+) polarity is applied to the scan electrode Y, and a GND voltage is applied to the sustain electrode Z. If the stabilization waveform signal is applied to the address electrode X such that the address electrode X has an address voltage Va, no discharge occurs between the address electrode X and the scan electrode Y or between the address electrode X and the sustain electrode Z, and a sustain discharge normally occurs only between the scan electrode Y and the sustain electrode Z. After the stabilization waveform signal is completely applied to the address electrode X, a GND voltage is applied to the address electrode X and the sustain electrode Z, such that no current signal flows in the address electrode X and the sustain electrode Z, and a normal sustain discharge continuously occurs between the scan electrode Y and the sustain electrode Z.

In an alternative embodiment, the stabilization waveform signal may be applied to the address electrode X may be terminated before reaching an address period of a neighboring subfield. In other words, the address electrode X continuously has the above-mentioned waveform signal during the sustain period S, and the waveform signal may be terminated after the lapse of the sustain period S. For example, if the stabilization waveform signal is maintained during the sustain period S, and is then terminated before or at the reset period R′ of the next subfield begins, as shown in FIG. 4e, the peaking noise does not flow in the scan electrode Y, the sustain electrode Z, and the address electrode X. Simultaneously, the sustain discharge is stably generated between the scan electrode Y and the sustain electrode Z during the sustain period S.

The stabilization waveform signal may have a signal waveform different from that of a constant voltage Va applied to the address electrode X in response to the last scan pulse (scp). After the data is substantially recorded in the address electrode X at “a”, some parts of the stabilization waveform signal applied to the address electrode X may be higher or less than a maximum voltage level of the data pulse (dp) having a preferred voltage of Va. In this case, if the address electrode X has a predetermined voltage, a current path from the scan electrode Y and the sustain electrode Z to the address electrode X is not formed when a voltage level of the scan electrode Y or the sustain electrode Z is changed, resulting in no peaking noise.

The stabilization waveform signal applied to the address electrode X to prevent the occurrence of the peaking noise may be terminated when the scan electrode Y and the sustain electrode Z have a GND voltage before the first sustain pulse (sus1) is applied to the scan electrode Y or the sustain electrode Z, or may also be terminated during a reception time of the sustain pulse (sus). Alternatively, the stabilization waveform signal may be terminated before reaching the address period of the next subfield after the lapse of the reception time of the sustain pulse (sus).

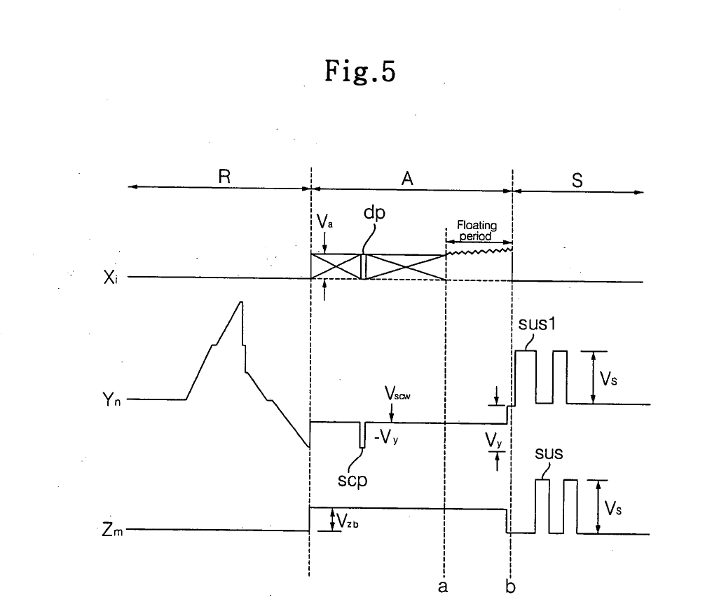

As shown in FIG. 5, the stabilization waveform signal is formed by the floating of the address electrode X. If the floating of the address electrode X occurs, a current signal is not transmitted from the scan electrode Y and the sustain electrode X to the address electrode X, resulting in no peaking noise. In other words, if the floating of the address electrode X occurs, a switch capable of transmitting the data pulse (dp) to the address electrode X is switched off, such that a current signal cannot be received from the scan electrode Y and the sustain electrode Z, resulting in the prevention of the peaking noise.

In this case, a data driver capable of transmitting the data pulse (dp) to the address electrode X controls the floating of the address electrode X. The data driver controls a signal line of the switch for operations of the data pulse (dp) and a dummy data pulse, such that the floating of the dummy data pulse occurs.

The floating start time of the address electrode X preferably begins after substantially all the data is recorded in the address electrode X. The floating end time of the address electrode X preferably is set to a specific time at which the scan electrode Y and the sustain electrode Z have a GND voltage before the first sustain pulse (sus1) is applied to the scan electrode or the sustain electrode Z. The address electrode X, the scan electrode Y, and the sustain electrode Z preferably have a GND voltage when the floating of the address electrode Z is terminated, such that a current signal is not transmitted from the scan electrode Y or the sustain electrode Z to the address electrode Z, resulting in no peaking noise.

Generally, the floating end time may be set to various time points. Particularly, the floating end time may be terminated during the sustain period S in the same manner as in the above-mentioned other preferred embodiments, and may also be terminated before the address period of the next subfield begins after the lapse of the sustain period S.

Typically, if the data pulse (dp) associated with video data is completely received at “a”, one or more dummy data pulses (not shown) are applied to the address electrode X. The dummy data pulse is indicative of a pulse signal for data stabilization after the data pulse (dp) based on video data is completely received. The dummy data pulse is indicative of an input signal irrespective of an image displayed on a screen, such that a pulse width of the dummy data pulse may be equal to or different from the data pulse as necessary.

Typically, the dummy data pulse has a pulse width greater than that of the data pulse, and the pulse width of the dummy data pulse is set to a predetermined value of 0.5 μs˜10 μs. The floating start time of the address electrode X may begin during a reception time of the dummy data pulse. The dummy data pulse is indicative of a pulse signal for data stabilization after substantial video data is recorded in the address electrode X, such that there is no influence on an image displayed on a PDP although the address electrode X is floated during the reception time of the dummy data pulse. If the floating of the address electrode X occurs during the reception time of the dummy data pulse, a current signal is not transmitted from the scan electrode Y and the sustain electrode to the address electrode X, resulting in no peaking noise.

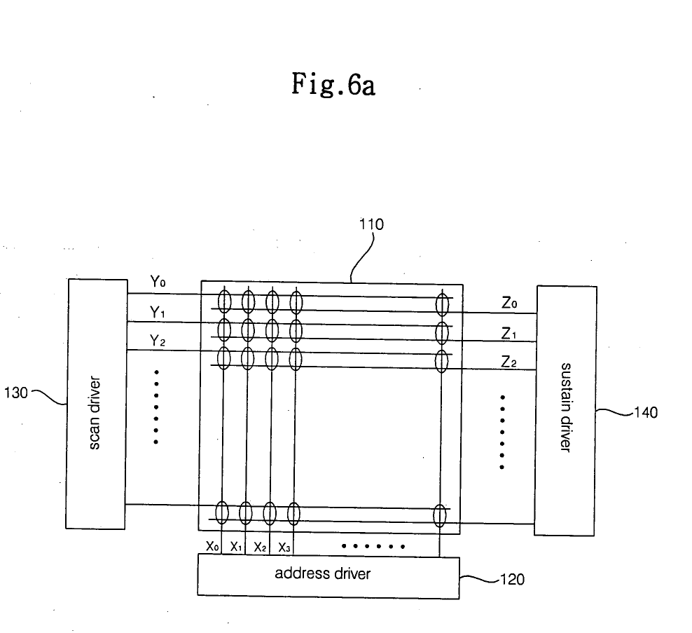

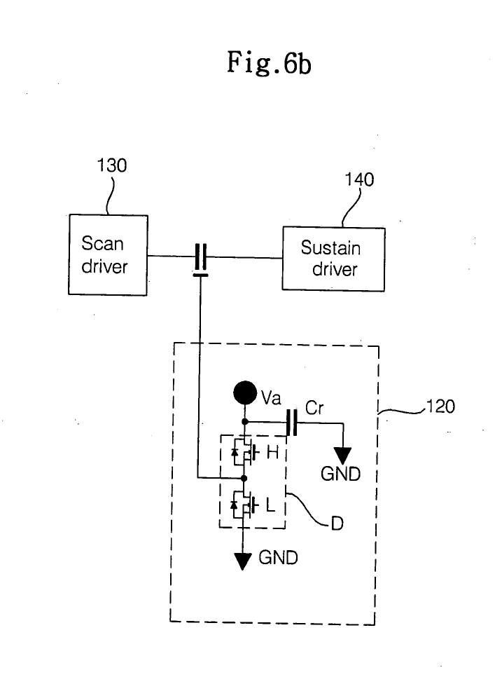

FIGS. 6a˜6b, 7, and 8a˜8c show an apparatus and method for driving a PDP according to the present invention. FIG. 6a illustrates the plasma display panel 110 being driven by an address driver 120, a scan driver 130 and a sustain driver 140, and FIG. 6b illustrates a detailed schematic of the address driver for a corresponding data line to a discharge cell.

A data driver 120 provides a data pulse (dp) to the address electrode X. The data driver 120 performs data sampling, latches the sampled data, and provides the data pulse (dp) to the address electrode X. The scan driver 130 provides the scan pulse (scp) and the sustain pulse (sus) to the scan electrode Y. The sustain driver 140 provides the sustain pulse (sus) to the sustain electrode Z. The sustain driver 140 and the scan driver 130 are alternately operated during the sustain period.

As shown in FIG. 6, the application of the data pulse (dp) is controlled by switches H and L of the data driver 120. The on/off times of the switches H and L are controlled such that the data pulse (dp) is applied to the address electrode X. The switch H is a high-level switch for providing the data pulse (dp) of the address voltage (Va) to the address electrode X. The switch L is indicative of a low-level switch for transmitting a GND voltage to the address electrode X. If the switch H is turned on, the address voltage (Va) is applied to the address electrode X. Preferably, the high-level switch and the low-level switch are transistors, either NMOS or PMOS, but preferably, NMOS transistors.

In order to prevent the occurrence of the peaking noise, the data driver 120 transmits a predetermined stabilization waveform signal to the address electrode X after the of the scan pulse (scp) for the last scan electrode. The stabilization waveform signal applied to the address electrode Z may have the same voltage level as that of the data pulse (dp) having a voltage Va, or may be higher or less than a maximum voltage level Va of the data pulse (dp).

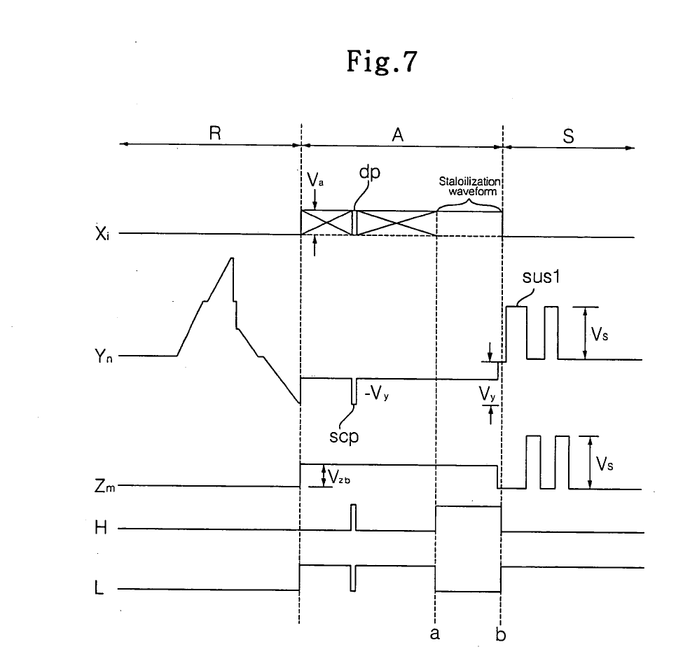

As shown in FIG. 7, the data driver 120 switches based on the gate signal on the high-level switch H and turns off the low level signal, such that it applies the data pulse (dp) to the address electrode X in response to the last scan pulse (scp). Thereafter, the data driver 120 continuously switches on the high-level switch H, such that the address electrode X can maintain a voltage level of the data pulse (dp).

Preferably, the stabilization waveform signal may be terminated before the first sustain pulse (sus1) is applied to the scan electrode Y or the sustain electrode Z, as shown in FIGS. 4a and 7. The scan electrode Y and the sustain electrode Z have a GND voltage before the first sustain pulse (sus1) is applied to the scan electrode Y or the sustain electrode Z. If the high-level switch H is switched off and the low-level switch L is switched on at point “b”, the address electrode X, the scan electrode Y, and the sustain electrode Z have a GND voltage, such that no current signal flows in the electrodes X, Y, and Z, resulting in no peaking noise.

The stabilization waveform signal may be terminated while the sustain pulse (sus) is applied to the scan electrode Y and the sustain electrode Z, as shown in FIGS. 4b, 4c and 4d, or may also be terminated before the address period A of the next subfield begins after the lapse of the sustain period S, as shown in FIG. 4e.

In other words, if the address electrode X has a predetermined voltage during the sustain period S, a voltage difference between the address electrode X and the scan electrode Y, or a voltage difference between the address electrode Z and the sustain electrode Z is reduced, such that the degree of sustain discharge formed between the scan electrode Y and the sustain electrode Z may be increased. Since there is no peaking noise, the present invention can stably maintain a state of wall charges formed in either the scan electrode Y or the sustain electrode Z prior to the sustain period S, and a voltage difference between the address electrode X and the scan electrode Y or a voltage difference between the address electrode X and the sustain electrode Z is reduced, such that there is no erroneous discharge. Since wall charges formed in the scan electrode Y or the sustain electrode Z are not scattered prior to the sustain period S, overdischarge occurs in the sustain period S, resulting in the prevention of the sputtering or blinking of a brilliant spot.

The data driver 120 performs the floating of the address electrode X after the last scan pulse (scp) is applied to the last scan electrode Y, resulting in the occurrence of a stabilization waveform signal. The data driver 120 controls a gate signal of the switches H and L for transmitting the data pulse (dp) to the address electrode X, such that it may float the address electrode X.

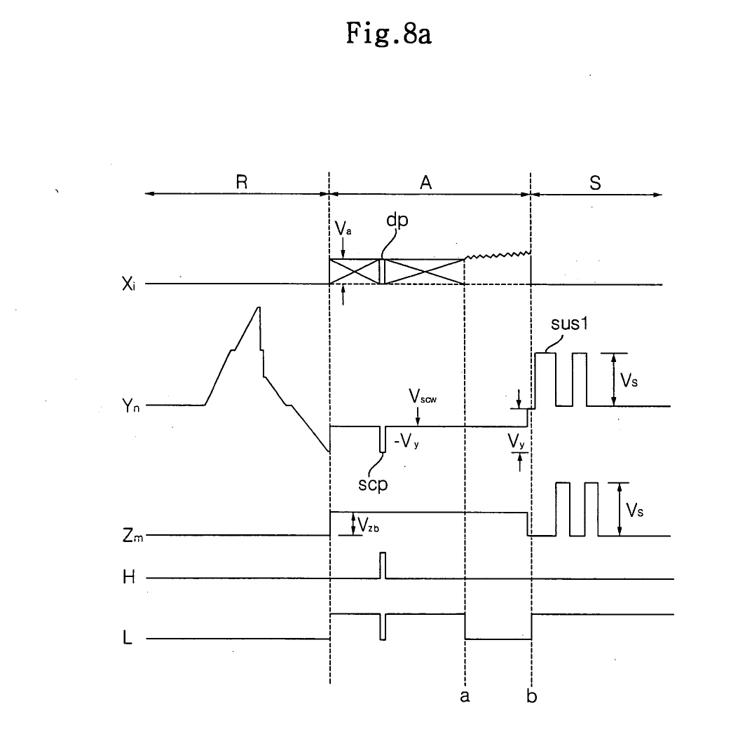

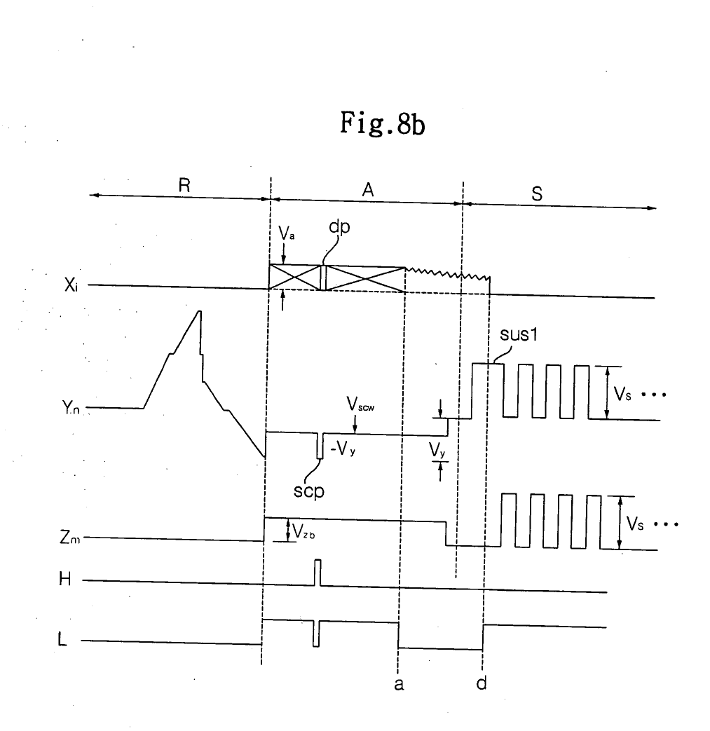

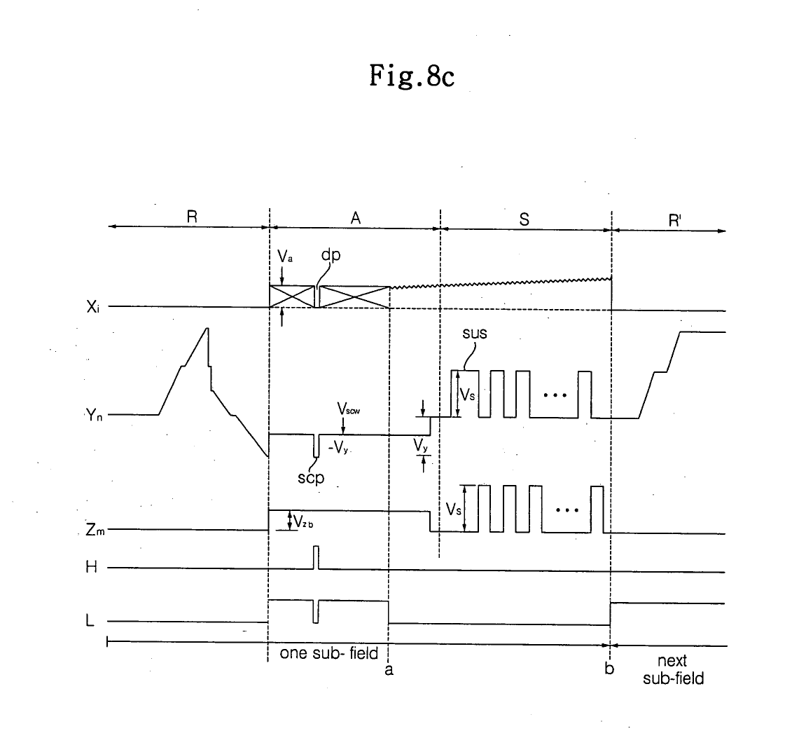

The floating of the address line can be implemented by turning off the high-level switch H and low level switch L between start time “a” and end time “b”, as shown in FIG. 8a. The address electrode X is floated, and at the same time the address electrode X has a predetermined voltage. The voltage formed by the floating of the address electrode X may be higher or less than a maximum voltage level of the data pulse (dp). The end time of the floating state, as shown in FIGS. 8b and 8c, can vary similar to FIGS. 4b˜4e, and all descriptions thereof are readily applicable and appreciated by one or ordinary skill. FIG. 8b illustrates an end time “d” similar to FIG. 4b, and FIG. 8c illustrates an end time similar to FIG. 4e.

In an alternative embodiment, the floating state of all the address electrodes may be maintained during the reset period R of the next subfield as necessary. A high voltage configured in the form of a ramp signal is applied to the scan electrode Y during the reset time, and a discharge occurs between the scan electrode Y and the sustain electrode Z by the high voltage, such that a discharge cell is initialized. As a result, although the address electrode X is floated, initialization of the discharge cell is not affected by the floating of the address electrode X.

If the data pulse (dp) is completely applied to the address electrode X, the data drive 120 transmits not only video data displayed on a screen, but also a dummy data pulse (not shown) to the address electrode X so as to perform a stable data record operation.

The dummy data pulse is applied to the address electrode X after the data pulse (dp) for a substantial data recording operation is applied to the address electrode X. Needless to say, the dummy data pulse can be different from the data pulse (dp) as necessary, such that the pulse width of the dummy data pulse is generally determined to be a predetermined value of 0.5 μs˜10 μs.

The dummy data pulse has the same voltage level as that of the data pulse (dp). Needless to say, the dummy data pulse can be higher or less than a maximum voltage level of the data pulse (dp) as necessary.

Therefore, if the floating of the address electrode X is performed during a reception time of the dummy data pulse, the data drive 120 prevents peaking noise from being generated, and guarantees a stable data recording operation. Also, the data drive 120 maintains a desired voltage level during a predetermined period of time, such that it prevents the peaking noise from being generated.

In this case, it should be noted that the floating end time of the address electrode X can be determined to be a variety of time points as described above.

As described above, if there is no peaking noise, wall charges formed between the scan electrode Y and the sustain electrode Z are stably maintained, a sustain discharge action occurs without generating an erroneous discharge action in the sustain period S. Further, peaking noise is undesirable since if the peaking noise occurs, a current signal flowing in the scan driver 130 or the sustain driver 140 is instantaneously increased. In this case, the switch contained in the scan driver 130 or the sustain driver 140 may be broken, such that a high current switch or a high voltage switch must be employed, resulting in increased production costs and/or decreased reliability of circuits, which is not required for the present invention. Also, if the peaking noise occurs, unexpected distortion occurs in the signal applied to the scan electrode Y and the sustain electrode Z, resulting in EMI (Electromagnetic Interference) deterioration.

Further, if a PDP is driven by a single-scan scheme, the magnitude of generable peaking noise is greater than that in the dual-scan scheme, such that circuit reliability and EMI may be greatly deteriorated by the peaking noise. However, if the peaking noise is eliminated as described above, a stable circuit can be configured even when the PDP is driven by the single-scan scheme, and at the same time EMI deterioration can also be prevented.

Figures are drawn for simplicity in explaining the invention. For example, the figures illustrate waveforms in an ideal situation, but as appreciated by one of ordinary skill in the art, other types of voltage spikes during voltage transitions, not related to this application, may be present in applications of such signals and/or waveforms. Further, the drawings have been illustrated to show pulses, but as appreciated by one of ordinary skill, these waveforms and/or signals may look different depending upon zooming or scale to illustrate such signals and/or waveforms.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A method for operating a plasma display panel having a plurality of scan, sustain and address electrodes, comprising:
applying a scan pulse to at least one scan electrode during an address period; and
applying a data pulse to at least one address electrode during the address period,
wherein a predetermined waveform signal having a voltage potential other than 0 volts or ground is provided to at least one address electrode after a last scan pulse is provide to the scan electrode.

2. The method according to claim 1, wherein the voltage potential corresponds to a voltage of the data pulse.

3. The method according to claim 1, wherein the voltage potential is different from a voltage of the data pulse.

4. The method according to claim 3, wherein the voltage potential is greater or less than a maximum voltage level of the data pulse.

5. The method according to claim 1, further comprising:
applying one or more sustain pulses to the at least one scan electrode during a sustain period.

6. The method according to claim 5, wherein the predetermined waveform signal is provided for a prescribed time period of the sustain period or is terminated before a first sustain pulse is applied to the at least one scan electrode.

7. The method according to claim 6, wherein the predetermined waveform signal is terminated when the at least one scan electrode is provided with a ground voltage before the first sustain pulse is applied to the at least one scan electrode.

8. The method according to claim 1, wherein the voltage potential is a floating potential.

9. The method according to claim 8, wherein the floating potential is provided by controlling a signal line connected to a plurality of switches of a data driver.

10. A plasma display panel apparatus, comprising:
a first drive circuit for applying a scan pulse to at least one scan electrode during an address period; and
a second drive circuit for applying a data pulse to an address electrode during the address period,
wherein the second drive circuit provides a predetermined waveform signal of a prescribed potential other than 0 volts or ground after a last scan pulse is applied to scan electrode.

11. The apparatus according to claim 10, wherein the voltage potential corresponds to a voltage of the data pulse.

12. The apparatus according to claim 10, wherein the voltage potential is different from a voltage of the data pulse.

13. The apparatus according to claim 12, wherein the voltage potential is greater or less than a maximum voltage level of the data pulse.

14. The apparatus according to claim 12, further comprising:
a third drive circuit for applying one or more sustain pulses to the at least one scan electrode during a sustain period.

15. The apparatus according to claim 14, wherein the stabilization waveform signal is provided for a prescribed time period of the sustain period or is terminated before a first sustain pulse is applied to the at least one scan electrode.

16. The apparatus according to claim 14, wherein the stabilization waveform signal is terminated when the at least one scan electrode is provided with a ground voltage before the first sustain pulse is applied to the at least one scan electrode.

17. The apparatus according to claim 10, wherein voltage potential is a floating potential.

18. The apparatus according to claim 17, wherein the floating potential is provided by controlling a signal line connected to a plurality of switches of the second drive circuit.

19. A plasma display panel, comprising:
a plurality of scan electrodes and sustain electrodes in a first direction;
a plurality of address electrodes in a second direction, which is substantially perpendicular to the first direction;
a plurality of cells, each cell being formed near or at an intersection of corresponding scan, sustain and address electrodes,
a driving circuit configured for driving at least one of the scan electrodes, sustain electrodes or address electrodes based on a plurality of sub-fields, wherein during an address period of at least one sub-field, a prescribed potential other than 0 volts or ground is provided to at least one address electrode after a last scan signal is provided to the scan electrode.

20. The plasma display panel of claim 19, wherein the driving circuit includes a scan driver to provide a scan signal to each scan electrode during a scan period of each sub-field and at least one sustain signal to each scan electrode during a sustain period of each sub-field.

21. The plasma display panel of claim 20, wherein the scan driver provides a reset signal to each scan electrode during a reset period of each sub-field.

22. The plasma display panel of claim 19, wherein the driving circuit further comprises a sustain driver to provide at least one sustain signal to at least one sustain electrode during a sustain period of each sub-field.

23. The plasma display panel of claim 19, wherein the driving circuit comprises an address driver to provide a data signal to each data electrode during an address period of each sub-frame, and maintaining the prescribed potential.

24. The plasma display panel of claim 19, wherein the prescribed potential is maintained for the plurality of address electrodes for one of (1) until an end of an address period of each sub-field, (2) during a prescribed period of a sustain period of each sub-field and (3) until a beginning of a subsequent sub-field.

25. The plasma display panel of claim 19, wherein the prescribed potential is one of a constant voltage equal to, less than and greater than a maximum data voltage.

26. The plasma display panel of claim 19, wherein the prescribed potential is a floating potential.

27. The plasma display panel of claim 26, wherein the floating potential is maintained until an address period of a subsequent sub-field.
